(19) United States
(12) Patent Application Publication
(10) Pub. No.: US 2015/0083684 A1
(43) Pub. Date: Mar. 26, 2015

(54) ROPE GUIDE FOR A CRANE

(71) Applicant: Manitowoc Crane Group France SAS, Dardilly Cedex (FR)

(72) Inventors: Jörg Böhm, Sande (DE); Erik Schaefer, Wilhelmshaven (DE); Volker Grassow, Wilhelmshaven (DE)

(21) Appl. No.: 14/494,236

(22) Filed: Sep. 23, 2014

(30) Foreign Application Priority Data
Sep. 24, 2013 (DE) 202013008487.1

(51) Int. Cl. B66C 23/62; B66C 23/70

(52) U.S. Cl. CPC B66C 23/62; B66C 23/701
USPC 212/348; 254/389

(57) ABSTRACT

A rope guide for a crane, in particular a rope guide for a telescopic crane, comprises at least one guiding element for a rope which extends from a boom head along the boom of the crane. The guide is characterized in that at least one of the guiding elements comprises a spacer which has, on its rope-sliding surface facing the rope and as viewed transversely to the direction of the rope's extension, a substantially round concave form. Embodiments have a spacer with one or more grooves which guide and accommodate the rope.

### RELATED APPLICATIONS

The present patent document claims the benefit of priority to German Patent Application No. 202013008487.1, filed Sep. 24, 2013, and entitled “ROPE GUIDE FOR A CRANE,” the entire contents of each of which are incorporated herein by reference.

### BACKGROUND

The invention relates to a rope guide for a crane, in particular a rope guide for a telescopic crane. It may be used for all crane ropes which extend along the crane boom, for example the hoist rope of the crane.

Generally speaking, such a hoist rope of the crane is guided across the top face of the crane boom from the hoist to the head reel. In this respect, precautions need to be taken to prevent the rope from brushing against the top face of the crane and different variations of guiding elements are used for this purpose in the prior art. Especially if the telescopic boom deforms under load, these guiding elements help to allow the rope to be freely guided without coming into contact with the boom's top face.

In the case of one known embodiment, the guiding elements have ball bearing mounted rope rollers across which the hoist rope can run. Such a design known from the prior art is illustrated in FIG. 6, which shows the front part of a retracted telescopic boom, the telescope sections of which have ball-bearing mounted rope rollers 23 on the top part of their cantilevers 20A to 20D, across which a hoist rope is able to run from a hoist, not illustrated, to the head reel 24 of the boom head 25. The line indicated by reference number 26 corresponds to the highest height of the boom in the parked and retracted state ready for transport, and it is clear that the height of the rope rollers 23 and their fixing means determines this highest height. The construction of the rope rollers 23 therefore means that extra height is needed, which conflicts with optimization of the boom cross-sections in the case of cranes bound by the 4-metre height restriction. Furthermore, in order to keep damage to the rope as low as possible as it runs across the rollers 23, it is necessary to keep to a minimum diameter for the rollers 23. In the case of large cranes which reach the 4-metre height limit, therefore, a compromise has to be struck between size and rope damage. For reasons pertaining to wear, it is necessary to use a roller made from a wear-resistant material (usually a steel roller), on the one hand because the local pressure intensity is too high for other materials (e.g. plastic) and on the other hand because in the case of 2-hook operation for example, two ropes run across the roller at the same time. One of them may be stationary whilst the other one is moving. Although this could still be compensated by segmenting the roller, this would make the overall construction very much more expensive due to the more complicated and additional mounting that would be needed.

Another option is to use rope rollers on the spacers in the case of larger cranes due to the large height requirement.

Another option would be to use plastic blocks, in which case such a plastic block would be disposed on the end of each and every telescope part, which would then enable the rope to conform to the elastic deformation of the boom. The disadvantage of this resides in the local high pressure intensity caused by the rigid connection and in the high degree of wear.

### BRIEF SUMMARY

The objective of this invention is to propose a rope guide for a crane which overcomes at least one of the above-mentioned problems known from the prior art. In particular, the intention is to optimize the rope guide by means of the spacers. This objective is achieved by the invention on the basis of a rope guide for a crane as defined in claim 1. The dependent claims define preferred embodiments of this invention.

Based on a rope guide for a crane as proposed by this invention, in particular a rope guide for a telescopic crane, at least one guiding element is provided for a rope which extends from a boom head along a boom or telescopic boom of the crane. At least one of the guiding elements comprises a spacer which has a concave form on its surface facing the rope, substantially complementing the rope contour.

In other words, this invention proposes a spacer with a friction-type bearing for the rope and the surface across which the rope glides or slides has a contour which is essentially adapted to the external contour of the rope. In principle, there need not be an exact match of contours but adapting to the round form will always increase the contact surface or sliding surface and thus will significantly reduce the pressure intensity which occurs.

The reduced pressure intensity between the rope and its sliding surface achieved by the invention enables a reduction in pressure intensity of up to 80% or even 90% to be achieved if an appropriate contour is selected. This results in a number of advantages and one of them is the significantly reduced damage to the rope, which is significantly less than the rope damage which occurs in the case of multi-layered spooling on the hoist. Accordingly, rope damage on the hoist remains the crucial feature in terms of structural design for addressing this wear factor and corresponding calculations need to be made an remain reliable. Other advantages of reduced load on the rope are an essentially longer service life of both the rope and the spacers or guiding elements and the fact that, due to the optimized surface structure, a sufficiently long service life can be achieved with very little material. As anti-friction elements, the guiding elements or spacers are based on a very simple construction and are thus virtually substantially maintenance-free and require only a minimal height for fitting. The latter advantage offers room for optimizing the boom and in turn options for optimizing the ultimate load.

Based on one embodiment of the invention, the spacer surface (rope-sliding surface) has at least one groove in the rope direction. The complementary form mentioned above means adapting the rope external form and concave inner form to a greater or lesser degree, i.e. from large radii on the sliding surface down to relatively small radii, which are highly adapted to the rope radius. In this respect, optimization will depend on the respective situation and various appropriate adaptations are possible. The embodiment incorporating a groove in the rope direction demonstrates that it is not necessary for the entire spacer to have a concave form on its sliding surface for the purpose of the invention—instead, it may be rounded in such a way across only a certain region of its width transversely to the rope direction and may be of some other appropriate design otherwise. As stated, at least one groove may be provided.

However, another option is for the spacer surface to be designed so that it has several adjacently lying grooves in the rope direction. These are of particular advantage when operating in 2-hook mode for example, because the two hoist ropes can then find a space in individual adjacently lying grooves. Similarly, an individual hoist rope may also sit in another groove with this embodiment, depending on the load situation or curvature of the boom, thereby ensuring effective guiding in every situation.

One option is to provide raised projections between the grooves with side walls sloping down towards the grooves, as a result of which the guided rope always slides down into one of the grooves where it will also be stabilized from the sides accordingly. If opting for a design where the projections are round or rounded on their top face, load or wear on the rope when “switching” groove will be reduced or eliminated.

Based on one embodiment, the spacers have a rope support, which is outwardly cambered in an arcuate shape in the direction in which the rope runs or, in other words, has a convex form in this direction. This ensures that the rope does not have to run over the front edge or rear edge of the rope support even in the event of pronounced deformation of the telescopic boom, which would result in increased pressure intensity and greater wear.

The rope-sliding surface or, in other words, the rope support of the spacer, may be provided with a coating, the hardness of which is higher than that of the rope. Another or additional option is for the rope support or even the entire spacer to be made entirely from a material with a higher hardness than that of the rope. In both situations, the coating or the rope support material is resistant to abrasion with respect to the rope friction or rope material. Naturally, the advantage of this is the fact that wear on the spacer at the rope-sliding surface is low, which results in long periods between maintenance and replacement as well as reliable operation.

The coating or the rope support material used for embodiments of this invention are selected from at least one of the following materials or incorporates one of the following materials:

sheet metal, in particular hardened sheet metal,

Hardox ® Extreme, made by SSAB AB of Klarabergsviadukten 70, D6, 10121 Stockholm, SE, having the following properties:
thickness: 8-19 mm
typical hardness HRC: 57-63
chemical composition:

| C Max % | Si Max % | Mn Max % | P Max % | S Max % | Cr Max % | Ni Max % | Mo Max % | B Max % |
|---|---|---|---|---|---|---|---|---|
| 0.47 | 0.50 | 1.0 | 0.015 | 10 | 1.20 | 2.50 | 0.80 | 0.005 |

thin films with
Titanium carbon nitride,
Titanium aluminium nitride or
DCL (Diamond-Like-Carbon =PACVD film =film of plasma-assisted CVD (Chemical Vapor Deposition)-method),

aluminium oxide,

zirconium oxide.

Based on one embodiment, the spacers are mounted on the boom so that they can move or are fixed. They may be mounted on or secured to the boom so as to be flexible and/or elastic and/or capable of rebounding into their initial position, and the mounting or fixing of the spacers on the boom may be such that the angle of the spacers relative to the longitudinal direction of the telescopic boom can be adjusted. Another option is to mount or secure the spacers on the boom via a mechanical, rigid mounting or fixing element or mechanism and impart flexibility via an elastic material inserted between the fixing element and spacer. Alternatively, the ability of the spacer to move and/or for its angle to be adjusted may also be achieved on the basis of the intrinsic elasticity of its material. Yet another option is for the spacers to be mounted on or secured to the boom via of a fixing element or mechanism that is flexible or can be moved in order to adjust the angle, in particular by way of an articulated fixing mechanism or a fixing mechanism incorporating a joint.

All of these embodiments with the displaceable spacers make it possible for guiding of the rope or deflection of the rope by the spacers to be adapted to different loads of the boom. This enables different degrees of deformation of the boom as a whole to be compensated, i.e. the rope guide is able to “conform” to these deformations at a distance from the boom. Assembly is also made easier.

In principle, it is possible to mount a rope guide for a crane of the type proposed by this invention on a crane with a simple, non-telescopic boom. In this instance, it would be of practical advantage to secure the guiding element or the spacer on the boom more centrally at the top so that the rope is able to conform to deformations at a distance from the boom surface.

In some of the different variants, however, the boom is a telescopic boom and guiding elements or spacers are disposed on each or several or every second, third or fourth telescope part, in particular at its front end, thereby enabling the rope guide to be optimized to suit the respective application. Naturally, depending on which embodiment is required and the requirements of the specific application, spacers may be provided at all possible regular distances and irregular distances on the telescopic boom.

### BRIEF DESCRIPTION OF THE DRAWINGS

The invention will be described in more detail below with reference to embodiments and with the aid of the appended drawings. Of the drawings:

FIG. 1 is a side view of the front part of a mobile crane, the telescopic boom of which is equipped with a rope guide as proposed by this invention;

FIG. 2 is a view seen from above at an angle showing the three front telescope sections of the boom illustrated in FIG. 1;

FIG. 3 is a side view of a spacer as proposed by this invention;

FIG. 4 shows the rope support of a spacer proposed by this invention seen from an angle;

FIG. 5 is a more detailed view showing the rope support with its grooved surface contour; and

FIG. 6 shows the front part of a telescopic boom with a roller rope guide known from the prior art.

### DETAILED DESCRIPTION

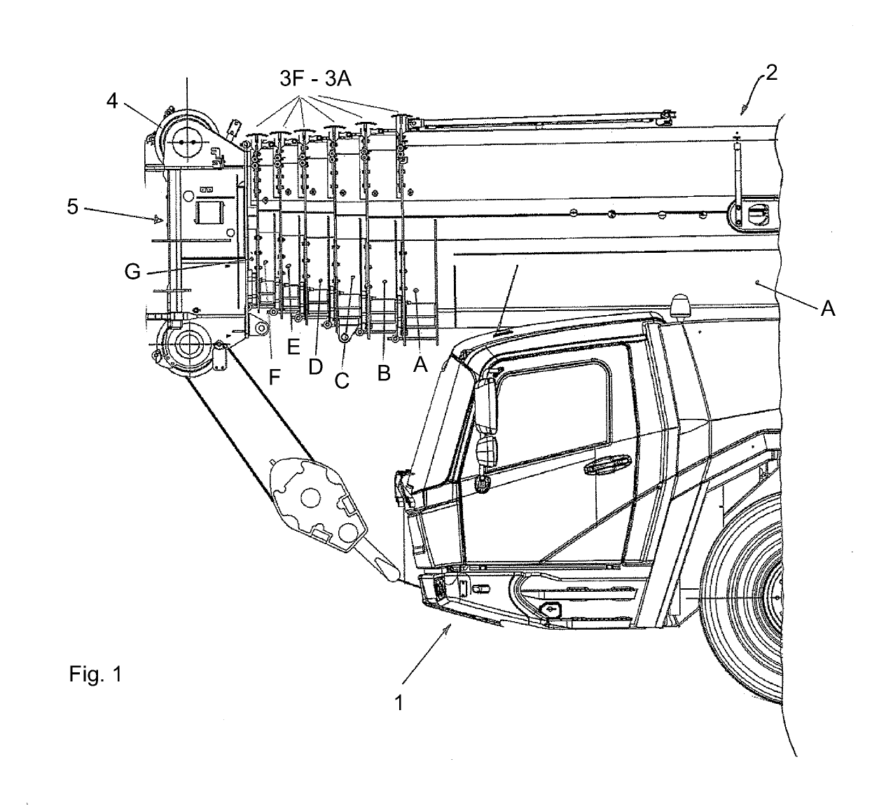

FIG. 1 illustrates the front part of a mobile crane 1 with a parked and retracted telescopic boom 2, comprising a main section A as well as other sections B, C, D, E, F and G nested one inside the other, and the boom head 5 is disposed on the last, innermost section G. The spacers 3A to 3F are disposed on the top face and at the front on the respective sections A to F. Their special design will be described in more detail below.

At this stage, an explanation of the concepts and definitions used in the context of the description of this invention will be given. The invention is defined as being a rope guide for a crane in order to introduce the design of its guiding elements and spacers into the appropriate technical field. However, their characterizing, inventive features may be implemented as broadly as possible and in almost all embodiments incorporating the design of the guiding elements and spacers which might constitute the subject matter of the invention as such in this sense. In this disclosure, “guiding elements” should be understood as meaning specifically the “spacers” in many cases—however, the guiding elements could in principle also be additional components or have other features or properties which do not have any direct bearing on the spacer function. For example, the expression “guiding element” might also include jib fixing means for the spacers. Accordingly, “guiding element” may also be construed as a generic term for “spacer”.

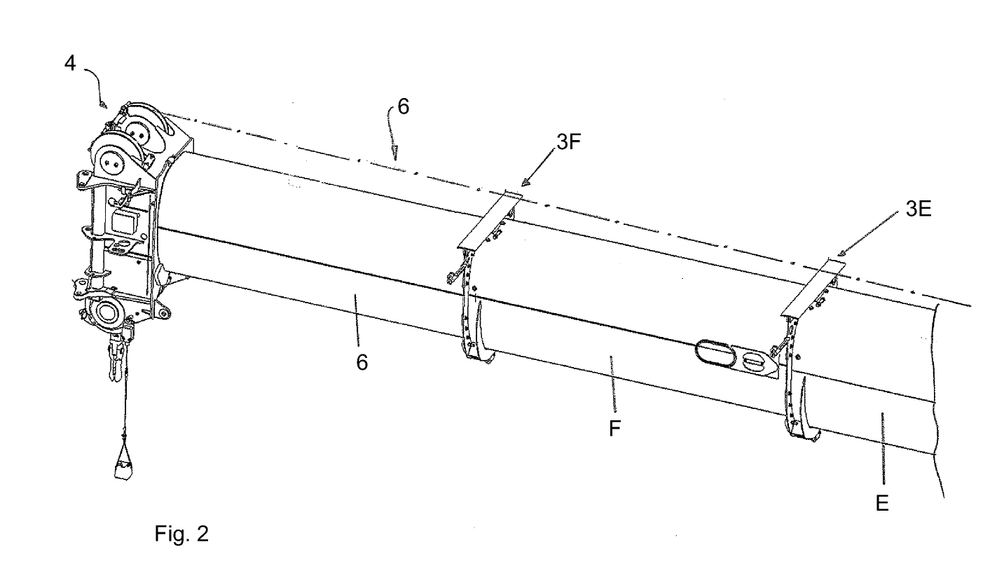

FIG. 2 illustrates more clearly how spacers 3F and 3E are mounted respectively in the cantilever region right at the front on the telescope sections F and E on the top face so that the rope 6 indicated by a dotted-dashed line is can be run out on one of its peripheral sides from the head reel 4 along the top of the telescopic boom and downwards, sliding across the surface of the spacers 3F and 3E. The innermost foremost section G no longer has any spacers because the task of the rope guide is assumed by the head reel 4 here. Looking at FIG. 2, one can also imagine that another rope could also be guided across the other head reel, although this is not illustrated, and across these same spacers 3F and 3E, which is possible without having to segment the latter or opt for a multi-part design.

Although FIGS. 1 and 2 illustrate the spacers mounted at the front in the cantilever region, in the case of telescopic cranes in particular, it is also generally speaking possible to opt for a mounting in the front third of the section or in another longitudinal position.

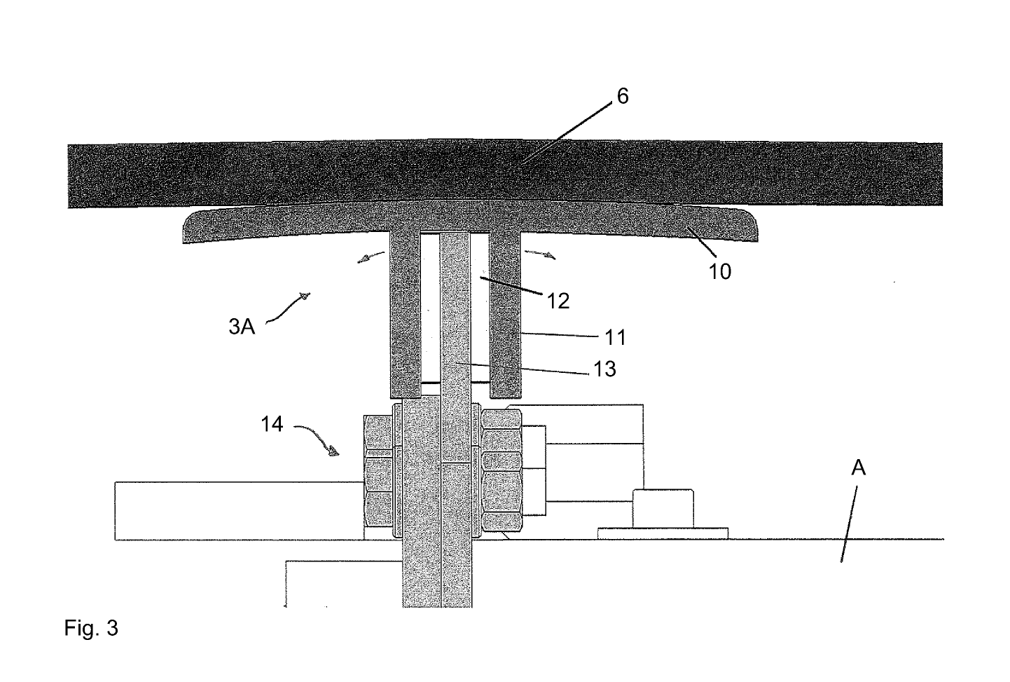

To provide more detail, one of the spacers 3A is illustrated in FIG. 3 in a side view transversely to the boom. The way it is secured—in this instance on the cantilever region of the main section A—and its detailed design may be seen.

An upwardly extending bearing plate 13 is mounted on the section A by way of a screw fixing 14. Placed around this bearing plate 13 on either side are layers 12 of an elastomer material, onto which the spacer 3A with two bottom webs 11 is positioned so that the two webs 11 grip tightly around the elastomer layers 12 from outside. Adjoining the two webs 11 at the top is the rope support 10 of the spacer 3A, and a rope 6 is illustrated lying on it.

The elastomer material 12 used between the webs 11 and the bearing plate 13 ensures that the spacer 3A is able to move elastically in the direction indicated by the two small arrows and its angle can thus be adjusted to enable it to conform to different deformations resulting from different loads. As explained above, this angular adjustability can also be achieved by various other means, for example by articulated bearings or on the basis of the intrinsic elasticity of the components of the spacer itself or that of its fixing elements.

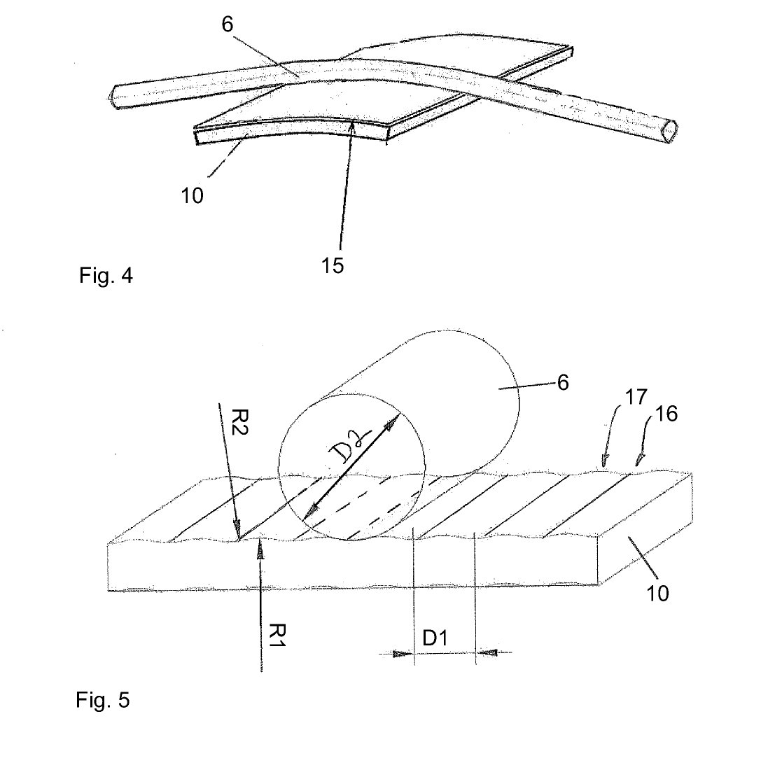

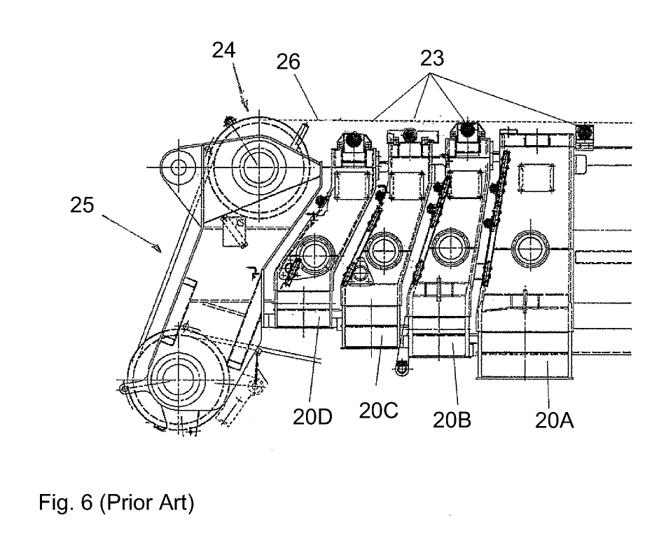

One property of the rope support may be seen in FIGS. 3 and 4, namely its top rounded, slightly convex form in the direction in which the rope 6 extends. In conjunction with the angular adjustability, this rounded form additionally ensures that the rope 6 does not run directly at an angle solely on the edge of the rope support 10 as it slides, thereby optimally avoiding high pressure intensity and damage to the rope 6 as a result.

Whereas the rope support 10 illustrated in FIG. 3 is of an integral design, the embodiment illustrated in FIG. 4 is a rope support 10 provided with a coating 15. Either the rope support 10 itself (FIG. 3) or the coating 15 is made from a material having a hardness higher than that of the rope 6, and reference may be made to the possible materials and coatings mentioned above which may be used for this purpose. The advantages relating to wear and resultant damage to the rope 6 just in the case of multi-layered spooling on the hoist were also described above and reference may be made to these.

The concave design (transversely to the rope direction) of the rope-sliding surface may be seen in FIG. 5, where several adjacently lying, concave, rounded recesses result in grooves 16 in the direction in which the rope runs, which alternate with projections 17. The radii R1 of the projections 17 are selected so that the rope 6 dwells only briefly on the projection 17 if a transverse force is imparted to the rope 6 as the rope 6 slides so that the rope 6 rapidly moves back into an adjacently disposed groove 16. The radius R2 of the grooves 16 as well as the distance D1 between each of the grooves 16 are adapted to the diameter D2 of the rope 6 so that the stress as the rope 6 slides into the grooves 16 results in a distributed load whereby the pressure intensity is reduced to 10% to 20% of what it would be in the situation where a rope was simply running on a straight surface without grooves.

With the aid of the angular adjustability, this state is also maintained in the event of different and pronounced boom deformations. Damage to the rope remains well below the damage incurred with multi-layered spooling, 2-hook operation is made possible, optimum use can be made of the design height and the service life can be increased with less maintenance.

1. A rope guide for a crane, in particular a telescopic crane rope guide, comprising at least one guiding element for a rope which extends from a boom head along a boom or a telescopic boom of the crane, wherein the at least one of the guiding element comprises at least one spacer with a surface facing the rope, the surface including a concave form in at least certain portions of the surface substantially complementing a contour of the rope.

2. The rope guide for a crane as claimed in claim 1, wherein the surface of the spacer has at least one groove in a direction in which the rope runs.

3. The rope guide for a crane as claimed in claim 1, wherein the surface of the spacer has several adjacently lying grooves in a direction in which the rope runs.

4. The rope guide for a crane as claimed in claim 3, further comprising a plurality of raised projections with side walls sloping down towards the grooves and that are disposed between the grooves.

5. The rope guide for a crane as claimed in claim 4, wherein the projections are rounded at a top face of each projection.

6. The rope guide for a crane as claimed in claim 1, wherein the spacer further comprises a rope support that is at least one of outwardly cambered in an arcuate shape and convex in a direction in which the rope runs.

7. The rope guide for a crane as claimed in claim 1, wherein the spacer further comprises a rope support including a coating having a hardness that is higher than a hardness of the rope.

8. The rope guide for a crane as claimed in claim 1, wherein the spacer further comprises a rope support made from a material having a hardness that is higher than a hardness of the rope.

9. The rope guide for a crane as claimed in claim 7, wherein the coating is resistant to abrasion from at least one of a friction from the rope and a material of the rope.

10. The rope guide for a crane as claimed in claim 8, wherein the material of the rope support is resistant to abrasion from at least one of a friction from the rope and a material of the rope.

11. The rope guide for a crane as claimed in claim 7, wherein the coating includes at least one of the following materials:
a) sheet metal, in particular hardened sheet metal;
b) Hardox ® Extreme, made by SSAB, with the following properties:
thickness: 8-19 mm
typical hardness HRC: 57-63
chemical composition:

| C Max % | Si Max % | Mn Max % | P Max % | S Max % | Cr Max % | Ni Max % | Mo Max % | B Max % |
|---|---|---|---|---|---|---|---|---|
| 0.47 | 0.50 | 1.0 | 0.015 | 10 | 1.20 | 2.50 | 0..80 | 0.005 |

c) thin films that include at least one of
titanium carbon nitride;
titanium aluminium nitride; and,
Diamond-Like-Carbon;
d) aluminium oxide; and,
e) zirconium oxide.

12. The rope guide for a crane as claimed in claim 8, wherein the material of the rope support includes at least one of the following materials:
a) sheet metal, in particular hardened sheet metal;
b) Hardox ® Extreme, made by SSAB, with the following properties:
thickness: 8-19 mm
typical hardness HRC: 57-63
chemical composition:

| C Max % | Si Max % | Mn Max % | P Max % | S Max % | Cr Max % | Ni Max % | Mo Max % | B Max % |
|---|---|---|---|---|---|---|---|---|
| 0.47 | 0.50 | 1.0 | 0.015 | 10 | 1.20 | 2.50 | 0..80 | 0.005 |

c) thin films that include at least one of titanium carbon nitride;
titanium aluminium nitride; and, Diamond-Like-Carbon;
d) aluminium oxide; and,
e) zirconium oxide.

13. The rope guide for a crane as claimed in claim 1, wherein the spacer is configured to be at least one of displaceably mounted on and displaceably secured to the boom.

14. The rope guide for a crane as claimed in claim 1, wherein the spacer is configured to be at least one of mounted on and secured to the boom so as to be at least one of flexible, elastic, and capable of rebounding into an initial position of the spacer.

15. The rope guide for a crane as claimed in claim 1, further comprising a mounting element configured to fix the spacer on the boom, the mounting element being configured to adjust an angle of the spacers relative to a longitudinal direction of the telescopic boom.

16. The rope guide for a crane as claimed in claim 1, further comprising a plurality of mechanical, rigid fixing elements with an elastic material inserted in between each of the plurality of fixing elements, the fixing elements being configured to at least one of mount and secure the spacer to the boom.

17. The rope guide for a crane as claimed in claim 1, further comprising at least one mechanical, rigid fixing element configured to at least one of mount and secure the spacer to the boom, the fixing element being configured to at least one of move and adjust an angle of the spacer relative to a longitudinal direction of the telescopic boom by way of an elasticity of a material of the fixing element.

18. The rope guide for a crane as claimed in claim 1, further comprising at least one fixing element configured to at least one of mount and secure the spacer to the boom, the fixing element being configured to be at least one of flexible and adjustably angularly displaceable via at least one of an articulated fixing mechanism and a fixing mechanism incorporating a joint.

19. The rope guide for a crane as claimed in claim 1, wherein the boom is a telescopic boom comprising a plurality of telescopic parts, and the at least one spacer is disposed at a front end of one of the telescopic parts.

20. A rope guide for use on a crane with a boom, the rope guide being configured to support a rope that runs in a direction along a length of the boom, the rope guide comprising:
a spacer configured to support the rope, the spacer including:
a rope support extending in a direction in which the rope runs, the rope support having a top surface configured to support the rope and a bottom surface spaced apart from the top surface;
at least one web that extends from the bottom surface of the rope support towards the boom;
at least one layer coupled to the web, the at least one layer being formed from an elastomer;
a bearing plate coupled to the spacer; and,
a fixing mechanism configured to couple the bearing plate to the boom.
